(19) United States
(12) Patent Application Publication
(10) Pub. No.: US 2005/0160775 A1
(43) Pub. Date: Jul. 28, 2005

(54) Deadbolt

(76) Inventor: David John Evans, Willoughby (AU)

Correspondence Address: Gary M Anderson;Fulwider Patton Lee & Utecht, Suite 1550, 200 Oceangate, Long Beach, CA, 90802, US

(21) Appl. No.: 10/503,781

(22) PCT Filed: Feb. 7, 2003
(86) PCT No.: PCT/AU03/00125

(30) Foreign Application Priority Data
Feb. 7, 2002 (AU) PS 0394

(51) Int. Cl. E05B 65/06

(52) U.S. Cl. 70/129

(57) ABSTRACT

A lockable deadlock for face mounting has a housing and an axially displaceable securing bolt mounted in the housing and moveable between a retracted position and an extended position, the deadbolt further comprising locking means to lock the bolt in at least the extended position and retaining means to retain the bolt in the housing.

### TECHNICAL FIELD

This invention relates to a deadbolt.

BACKGROUND OF THE INVENTION

There are known deadbolts of the type where a bolt is secured in a housing which is adapted to be mounted on the face of a door or window or the like. The bolt can be moved into an extended position to engage with a keeper or the like. Such arrangements have been used in window or door security locks.

There is a need for an arrangement which would ameliorate at least one of the above problems.

Limitations exist in commonly known deadbolt arrangements and the present applicants envisage that new and useful alternatives with enhanced functionality would be desirable.

### SUMMARY OF THE INVENTION

In a first aspect, the present invention provides a deadbolt having a housing, a bolt mounted in the housing and movable in the direction of the length of the bolt between a retracted position and an extended position, locking means which can lock the bolt in the extended position and retaining means to prevent removal of the bolt from the housing without disassembly of the deadbolt. In this way, the bolt cannot be removed from the housing and thus cannot be accidentally separated or lost.

Accordingly, a new and useful alternative over the known deadbolts is provided for with the more sophisticated construction which will be exemplified in more detail below and for the purpose of retaining the bolt in the housing to prevent its accidental separation or loss.

The retaining means may include a projection extending laterally from the bolt for retaining the bolt in the housing. Use of such a projection avoids machining a narrowed portion of the bolt for locking purposes, thereby avoiding weakening the bolt.

A further advantageous feature now proposed by the present applicants is to provide an arrangement whereby the bolt can be secured and preferably locked in a retracted position so that it is not inadvertently moved to the extended or normal locking position with possible damage to surrounding structure. This may be achieved by providing for the locking means to lock the bolt in the retracted position and then the key can be removed to prevent unintentional locking or movement of the bolt.

The retaining means can include first and second abutment regions against which the projection will abut to restrain further axial motion of the bolt and to prevent removal of the bolt from the housing. This provides a simple mechanism for preventing removal of the bolt from the housing.

The deadbolt with advantage may include a detent such as a spring loaded finger which engages in a recess in the bolt so that it is positively located at each limit position, ie extended and retracted, and the user can feel and/or hear that this position has been reached. The spring loading will retain the bolt in that position to permit the user then to use a key to achieve any desired locking.

The locking means can further include a locking tongue which is movable between a locked and an unlocked position, for example by actuation of a key through a lock. In the locked position the projection is trapped between the locking tongue and either one of the abutment regions to restrain axial movement of the bolt.

With advantage, a lock of cylindrical form is provided for engagement with a key and, upon rotation of the key, there is motion transmitted through a cam and cam follower arrangement to displace the locking tongue.

The present invention lends itself to embodiments in which the orientation of the bolt within the housing may be reversed so that the lock may be selectively configured for right hand or left hand operation. This enables one model of lock to be manufactured.

For the purpose of providing improved durability, embodiments of the invention may utilise two laterally extending projections which, when locking is achieved, restrain axial movement of the bolt. This may be achieved by providing a pin extending through a transverse bore in the bolt, the respective projecting tip portions of the pin providing the engagement projections.

Advantageously, the pin may be a spring pin which is radially compressible for fitting into the bore so that easy installation during manufacture is possible.

Preferably, the deadbolt further includes another projection extending in an opposite direction to the projection. This improves the durability of the deadbolt over a single projection arrangement.

A further embodiment provides an alternative and advantageous structure wherein the bolt has an axial groove of relatively shallow depth extending into the side wall of the bolt, a recess deeper than the groove intersecting the groove at at least one end of the groove, and a displaceable projecting element is mounted to be operable when the bolt is in an extended position, responsive to operation of the locking means to engage in the recess thereby locking the bolt, unlocking of the bolt causing partial retraction of the projecting element whereby a tip of the projection is engaged within the groove and the bolt may be slideably moved from the locked position to a retracted position.

### BRIEF DESCRIPTION OF THE DRAWINGS

Embodiments of the present invention will now be described, by way of example only, with reference to the accompanying drawings, of which:

FIG. 1 is a front elevation of a deadbolt embodying the present invention;

FIG. 2 is a side elevation of the deadbolt of FIG. 1;

FIG. 3 is an underside view of the deadbolt of FIG. 1;

FIG. 4 is a side cross-sectional view of the deadbolt of FIG. 1 taken along the line A-A;

FIG. 5 is an inverted plan cross-sectional view of the deadbolt of FIG. 1 along the line B-B;

FIG. 6 is a plan cross-sectional view of the deadbolt of FIG. 1 along the line C-C;

FIG. 7 is an exploded view of the deadbolt of FIG. 1;

FIG. 8 is an isometric view of the deadbolt of FIG. 1 along with a keeper with the bolt in the extended position;

FIG. 9 is an isometric view of the deadbolt of FIG. 1 along with a keeper with the bolt in the retracted position;

FIG. 10 is an isometric view of the deadbolt of FIG. 1 shown with an alternative keeper;

FIG. 11 is a part-assembled side view taken along the lines XI-XI of FIG. 7;

FIG. 12 is an inverted plan, central cross-sectional view of a second embodiment and taken along the line E-E of FIG. 14;

FIG. 13 is a plan cross-sectional view through the axis of the cylinder lock of the embodiment of FIG. 14 and taken along the line F-F;

FIG. 14 is a front view of the second embodiment in the extended, locked position of the bolt;

FIG. 15 is a right hand end elevation of the embodiment of FIG. 14;

FIG. 16 is an inverted plan view of the embodiment of FIG. 14;

FIG. 17 is a cross-sectional side elevation taken along the line D-D of FIG. 14;

FIG. 18 is an exploded view of components of the deadbolt of FIGS. 12 to 17;

FIG. 19 is a partial view on an enlarged scale showing detail of the configuration in the locked position; and

FIG. 20 is a view corresponding to FIG. 19 but showing the components in the unlocked position.

### DETAILED DESCRIPTION OF THE EMBODIMENTS

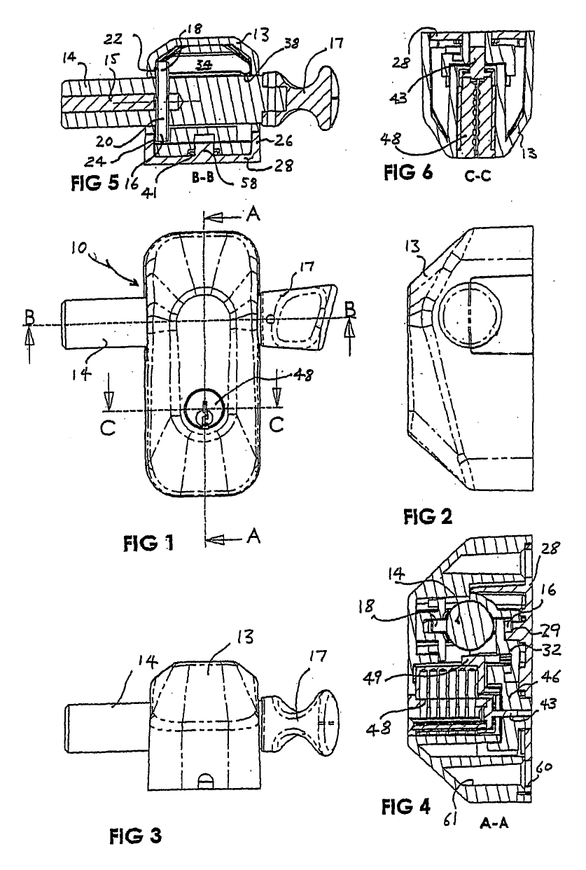

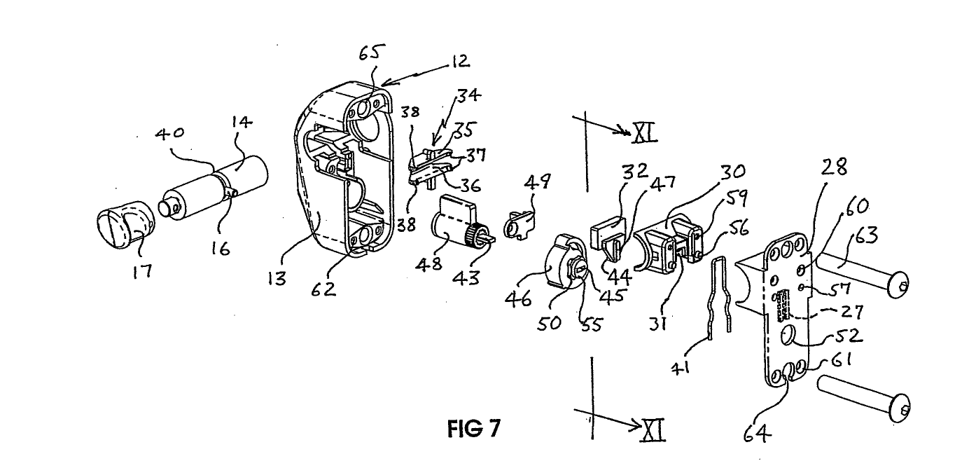

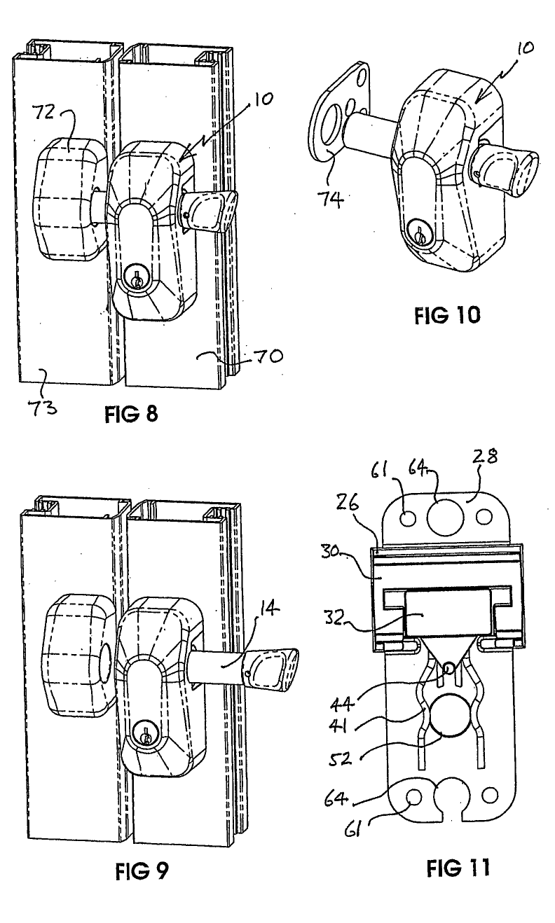

Referring to FIGS. 1 to 7, a deadbolt 10 is shown including a housing 12 and a bolt 14 mounted in housing 12. The housing 12 has a front cover 13 and backing plate 28. The bolt may be moved between a retracted position (see FIG. 9) and an extended position (see FIGS. 1-6 and 8).

The bolt 14 includes a cylindrical insert 15 (see FIG. 5) made from hardened metal located in an axial bore in the bolt to provide added security by resisting cutting of the bolt.

Bolt 14 includes a plastic handle 17. This allows a user to easily grasp bolt 14 for the purpose of moving it between the extended position and the retracted position.

The bolt mounts a transverse spring pin 20, having respective end projections 16 and 18, mounted in a cross-bore drilled in the bolt 14. Projection 16 extends into channel piece 30 which defines a channel 29, extending from an opening 31 which allows a locking tongue 32 to move into channel 29. When the locking tongue 32 is outside channel 29, projection 16 is free to move along the length of channel 29. When projection 16 is at either end of channel 29, locking tongue 32 may be introduced into channel 29 through opening 31 so that the locking tongue 32 then obstructs channel 29 and restricts the movement of projection 16 and hence restricts axial movement of bolt 14. The end of channel 29, at which projection 16 is located when locking tongue 32 enters channel 29, dictates whether bolt 14 is locked in the extended position or the retracted position.

The deadbolt 10 includes transverse abutment shoulders 22, 24 extending respectively in the cover 13 and baseplate 28 at right angles to the axis of the bolt 14, the shoulders 24 defining the ends of the channel 29. The projections 16, 18 of the spring pin 20 abut against these shoulders at the end of axial travel of the bolt to prevent removal of the bolt from the housing.

The deadbolt 10 includes a detent 34 which, as most clearly seen in FIG. 7, comprising spaced interconnected arms 35, 36 extending parallel to the bolt and biased onto bolt 14 by way of a spring (not shown) positioned between detent 34 and front cover 13. When bolt 14 is in the extended position, tip projections 37 (at the right hand end of the arm when viewed as in FIG. 7 but at the left hand end when viewed as in FIG. 5 but hidden from view in that Figure) engage with an annular recess 40 in the periphery of the bolt. The tip projections 37 and the recess 40 are obscured in FIG. 5 but shown in FIG. 7. When bolt 14 is in the retracted position, a second set of tip projections 38 engage with the annular recess 40. The bolt 14 may be pushed or pulled by hand to release engagement of the detent projections from the recess 40.

The bolt is mounted in the housing by being held between the detent 34 and channel piece 30. Detent 34 biases bolt 14 against channel piece 30 by way of the spring (not shown) to reduce rattle. Detent 34 and channel piece 30 are formed from a material which exhibits low friction when in contact with the material of the bolt to provide for smooth movement of the bolt. Typically detent 34 and channel piece 30 are moulded from an engineering grade polymer such as nylon and the bolt 14 is formed from metal such as stainless steel.

As most clearly shown in FIG. 7, a lock cylinder 48 is provided for key actuation and mounted in the housing. Lock cylinder 48 is retained in the front cover 13 by retaining element 49 which is secured by a screw (not shown) onto the interior of the cover 13. The lock has a rearwardly projecting tab 43 which engages in a corresponding slot 45 in a rotor 46 which has a cam groove 42 in which a lug 44 (functioning as a cam follower) is engaged, the lug 44 projecting from a base portion of the locking tongue 32. The locking tongue 32 has a rear spline 47 for engaging in a corresponding vertical groovelike guide 27 formed in the baseplate 28. Thus, rotation of a key in the lock cylinder 48 rotates the rotor 46 and the cam function then raises or lowers the tongue 32 into the channel 29 to establish a locked position and retracts the tongue out of the channel for an unlocked position.

A U-shaped spring clip 41 has legs which are biased against either sides of a dog 50 mounted on rotor 46. Clip 41 serves to positively locate rotor 46 at a selected rotary position. The angle of rotation required of rotor 46 to move locking tongue 32 between the locked position and the unlocked position is 90° and this corresponds to the profile of the dog 50. This feature gives the user tactile feedback that the correct amount of rotation has been performed by the key. Assembly is achieved by locating the upper portion of the spring 41 over a lug 58 (shown in FIG. 5) of the baseplate. The channel piece 30 is located in a cradle 27 of the baseplate with lugs 56 projecting rearwardly from the channel piece engaging in holes 57 in the baseplate and thereby aligning tapped bores 59 in the channel piece with screw-receiving holes 60 in the baseplate. The locking tongue 32 is inserted from below into the channel piece 30 and fixing screws used to retain the components on the baseplate.

The tip 55 of rotor 46 is inserted into a central aperture 52 of the baseplate with the dog 50 snap-fitting between the legs of the spring dip.

The deadbolt 10 is arranged such that it may be disassembled for the purpose of reversing the orientation of bolt 14. This allows the deadbolt 10 to operate in either a left handed or right handed configuration.

Installation, e.g. on a door, is achieved by assembly of the lock with screws (not shown) which pass through corner holes 61 in the backplate (see FIG. 7), the screws extending into an engaging tapped bores 62 formed in an internal body structure of the housing 12. The assembled unit is fixed to a structure such as a door by mounting screws 63 which pass through larger apertures to 64 in the baseplate to engage in respective major tapped bores 65 in the interior of the body of the housing 13.

Thus, no screws or bolts remain accessible from the front side of deadbolt 10 when it is mounted for use.

Referring to FIGS. 8 and 9, the deadbolt 10 is shown in use mounted to adjacent door frame member 70, FIG. 8 showing the deadbolt 10 in the extended or locked position in which the bolt 14 engages with keeper 72 mounted on a frame element 73. Keeper 72 is exposed and thus is fabricated to be strong for the purpose of resisting forcing of the lock.

Referring to FIG. 10, the deadbolt 10 is shown with alternative keeper 74. This form of keeper may be used when bolt engages with a hole drilled into a wall or into the floor, ground or ceiling or the like. The keeper 74 reinforces the hole and protects the hole from damage. If the material into which the hole is drilled is tough, keeper 74 may be dispensed with.

FIGS. 8, 9 and 10 show the deadbolt mounted vertically. It can also be mounted horizontally at the bottom of a frame to engage with the ground or at the top of a frame to engage with the top of the frame mounting member. The frame can be a hinged or sliding door.

The pin 20 is designed with a resilient form so that by its resilience it has retained the desired illustrated position in the cross-bore in the bolt. However, that form of pin may be replaced by a solid pin retained in a bore through bolt 14 by an interference fit.

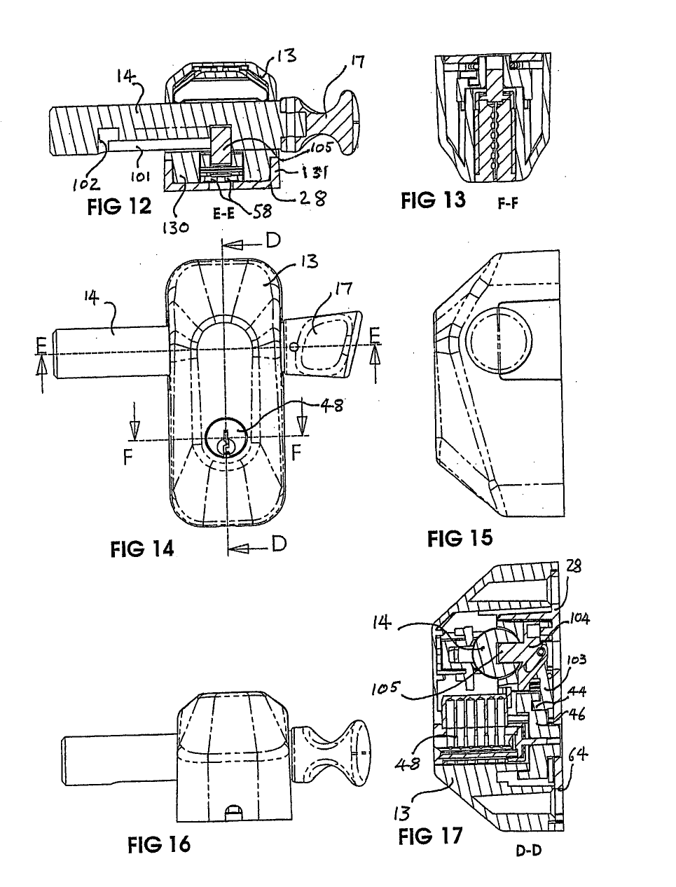

Reference will now be made to the second embodiment of FIGS. 12 to 20 where like parts have been given like reference numerals and only the variations will now be described in detail.

The principal differences in the second embodiment are a modification to the bolt 14 and the locking tongue arrangement to provide a different form of retention and locking of the bolt.

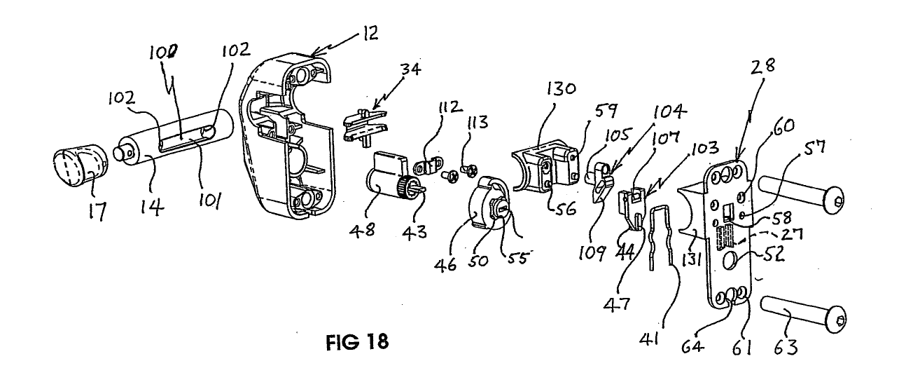

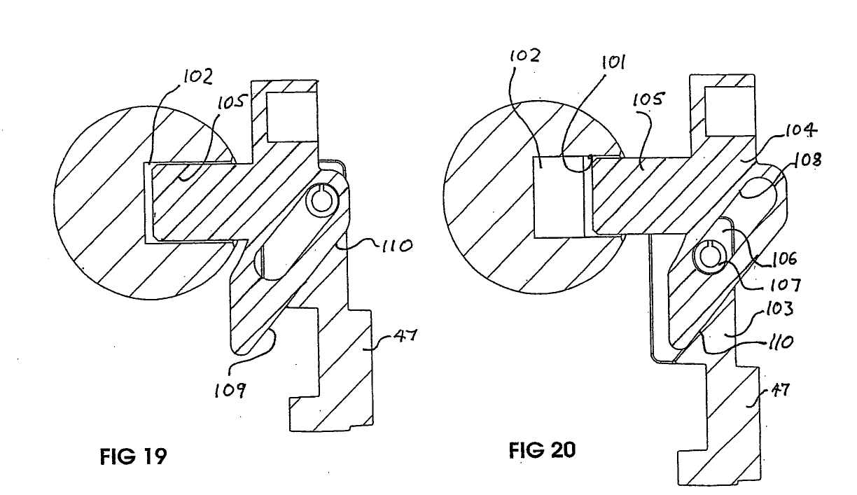

As most clearly shown in FIG. 18, the bolt 14 has an axially extending groove 100 having a central shallower profile 101 and deeper profiles 102 (best shown in FIG. 12) in the form of cylindrical partial cross-bores at each end region. The locking tongue is modified to form a two-part unit comprising a locking element 104, a vertically displaceable main body 103 which inter-engages with the backplate 28 on one side and the rotor 46 on the other side in the same manner as the first embodiment. However, the locking element 104 is displaceably mounted on the main body 103 with a cam action to cause it to have its axially projecting locking pin 105 move transversely to the axis of the bolt 14 and into its groove 100. Reference to FIGS. 19 and 20 shows the detail wherein the main body 103 has spaced, upwardly extending walls 106 across which a spring pin 107 is inserted after positioning the locking element 104 so that a slot 108 through the locking element receives the spring pin therethrough for retention purposes. An angled face 109 of the locking element extends parallel to the groove and provides a cam follower surface while the main body provides a corresponding cam surface 110 below the region of the spring pin. As shown in FIG. 20, in the unlocked position, the locking projection 105 of the locking element extends into the groove, but not into a deeper cross-bore 102, one of which is at each end of the groove. Therefore, the bolt can slide freely within the limits of the groove and is constrained against removal by axial end walls of the groove.

When the cylinder lock is rotated, the main body 103 is displaced vertically upwardly while constrained in a corresponding guideway 27 extending from the base plate 28 by engagement of the spline 47 and the cam surfaces engage to displace the locking pin 105 into the bolt 14. This can only occur when the bolt is at one of its end positions and the locking pin can extend into one of the deeper cross-bores 102.

Assembly of the unit is achieved by firstly positioning the spring clip 41 over the locating lug 58 on the baseplate and with the legs extending downwardly outside the location guide 27. The main body and locking element are assembled as shown most clearly in FIG. 20 and inserted upwardly into the channel piece 130 with the spline 47 engaging in the guide 27 and the channel piece then inter-engages with a cradle 131 of the baseplate, the cradle being integrally formed with the baseplate. The locating lugs 56 are engaged within the locating bores 57 in the baseplate in a similar manner to the mounting arrangement for the first embodiment.

A further minor alteration is that mounting of the cylinder lock is by a saddle 112 and two mounting screws 113 as shown in FIG. 18.

1. A deadbolt for face mounting comprising:
a housing;
a bolt mounted in the housing and movable in the direction of the length of the bolt between a retracted position and an extended position;
a locking means which can lock the bolt in the extended position; and
retaining means which further prevents removal of the bolt from the housing without disassembly of the deadbolt.

2. A deadbolt according to claim 1 wherein the locking means can further lock the bolt in the retracted position.

3. Amended) A deadbolt according to claim 1 wherein the retaining means includes a projection extending from the bolt in a direction outward from the direction of movement of the bolt.

4. A deadbolt according to claim 3 wherein the retaining means includes first and second abutment regions against which the projection abuts to prevent removal of the bolt from the housing.

5. A deadbolt according to claim 4 wherein the locking means includes a locking tongue which is movable between a locked and an unlocked position; in the locked position the projection is trapped between the locking tongue and either one of the abutment regions.

6. A deadbolt according to claim 5 wherein the locking means includes a cylinder lock and the locking tongue is in mechanical engagement with the cylinder lock and moves between the locked and unlocked position upon operation of the cylinder lock by a key.

7. A deadbolt according to claim 6 wherein the locking tongue is in mechanical engagement with the cylinder lock through a cam and follower arrangement.

8. A deadbolt according to claim 1 further including a detent arrangement to urge the bolt to remain in the extended position.

9. A deadbolt according to claim 8 in which the detent arrangement further acts to urge the bolt to remain in the retracted position.

10. A deadbolt according to claim 8 or wherein the detent arrangement comprises an element against the bolt and the bolt has a complementary recess to receive the element.

11. A deadbolt according to claim 1 wherein the bolt has a handle at one end.

12. A deadbolt according to claim 1 wherein the orientation of the bolt within the housing may be reversed so that the lock may be selectively configured for right hand or left hand operation.

13. A deadbolt according to claim 1 further including a second projection extending from the bolt in an opposite direction to that in which the projection extends.

14. A deadbolt according to claim 13 wherein the projection and the second projection are provided at opposite end portions of a pin inserted in a cross-bore through the bolt.

15. A deadbolt according to claim 14 wherein the pin is a resilient form and retained in the bore by virtue of a resilient fit.

16. A deadbolt as claimed in claim 1 and wherein the bolt has an axial groove of relatively shallow depth extending into the side wall of the bolt, a recess deeper than the groove intersecting the groove at at least one end of the groove, and a displaceable projecting element is mounted to be operable when the bolt is in an extended position, responsive to operation of the locking means to engage in the recess thereby locking the bolt, unlocking of the bolt causing partial retraction of the projecting element whereby a tip of the projection is engaged within the groove and the bolt may be slideably moved from the locked position to a retracted position.

17. A deadbolt as claimed in claim 16, wherein a cylinder lock is provided for rotating a rotor and the rotor displaces at right angles to the axis of the cylinder a connector element through a cam action and the connector element in turn controls displacement of the projecting element.

18. A deadbolt as claimed in claim 17, wherein the projection is mounted on a displaceable element driven by the connector through a cam action to displace the projection along an axis parallel to the axis of the lock cylinder and at right angles to the direction of the elongation of the groove.

19. A deadbolt as claimed in claim 1, wherein a spring is mounted to act as a detent to urge the locking means into defined limit positions.
